(19) United States
(12) Patent Application Publication
(10) Pub. No.: US 2013/0298876 A1
(43) Pub. Date: Nov. 14, 2013

(54) HEAVY DUTY PRESSURE INJECTION TIME PRESSURE FUEL INJECTION SYSTEM

(71) Applicants: James Stroup, Alto, GA (US); Feng Mo, Lewisville, TX (US); Ken Webb, Snellville, GA (US)

(72) Inventors: James Stroup, Alto, GA (US); Feng Mo, Lewisville, TX (US); Ken Webb, Snellville, GA (US)

(21) Appl. No.: 13/894,344

(22) Filed: May 14, 2013

Related U.S. Application Data
(60) Provisional application No. 61/646,840, filed on May 14, 2012.

(51) Int. Cl. F02D 41/30

(52) U.S. Cl. CPC F02D 41/30
USPC 123/478

(57) ABSTRACT

A fuel injection system that includes an electronic controller that senses engine speed, calculates energy required by an engine existing control unit based upon a signal sent to one or more diesel injection pressure and timing actuators and a plurality of gaseous fuel injectors that respond to commands from the electronic controller and inject gaseous fuel through an injection tube installed in an intake adapter plate fixed between an intake manifold and an engine block. The fuel injection system also includes an on and off switch assembly equipped with a self-diagnostic capability that lights an LED light when a fault in the port injector system is sensed and a blended fuel injector control unit installed between an ECM and a plurality of diesel fuel injectors.

This application claims priority to U.S. Provisional Application 61/646,840 filed on May 14, 2012, the entire disclosure of which is incorporated by reference.

### BACKGROUND OF THE INVENTION

1. Field of the Invention

The present invention is a diesel-gaseous fuel sequential port injector system. More specifically, the present invention is a heavy duty pressure injection time pressure fuel injection system.

2. Description of the Related Art

In practice the lower energy density of gaseous fuels such as CNG or LNG compared to diesel fuel and the differences of air to fuel burn ratios along with differences in molecular structures (i.e., fuel burn rates) are inherent hurdles to blending different fuel types. The fuel injection system adapts and allows a conventional diesel fueled engine to run on a blend of gaseous fuel in the form of natural gas (i.e., CNG or LNG) and diesel fuel as the primary or pilot fuel. The fuel injection system solves the torque and horsepower problem inherent with the introduction of low energy density gaseous fuel to the diesel engine by continuously adjusting the ratio of the diesel-to-gaseous fuel in the blended fuel being delivered to the engine.

When high torque or high horsepower is required, the ratio of diesel-to-gaseous fuel is high. When the torque or horsepower demand is low, such as cruising on highway or operating under minimal load, the ratio of diesel-to-gaseous fuel is low. The engine can therefore operate on a high content of gaseous fuel within in defined operational parameters without losing or enhancing any normal engine power characteristics or without adversely affecting any engine operating parameters. All OEM engine sensed parameters remain intact and are uninterrupted in integrity with the OEM engine management system.

### BRIEF SUMMARY OF THE INVENTION

The present invention is a fuel injection system. More specifically, the present invention is a heavy duty pressure injection time pressure fuel injection system.

The fuel injection system includes an electronic controller that senses engine speed, calculates energy required by an engine existing control unit based upon a signal sent to one or more diesel injection pressure and timing actuators and a plurality of gaseous fuel injectors that respond to commands from the electronic controller and inject gaseous fuel through an injection tube installed in an intake adapter plate fixed between an intake manifold and an engine block. The fuel injection system also includes an on and off switch assembly equipped with a self-diagnostic capability that lights an amber light emitting diode light or LED light when a fault in the port injector system is sensed and a blended fuel injector control unit installed between an ECM and a plurality of diesel fuel injectors.

The fuel injection system converts heavy duty or HD on-highway diesel fueled engines to operate on a blend of natural gas (i.e., CNG/LNG) and diesel. The conversion is transparent to the existing engine management controller or ECM.

It is an object of the present invention to provide a fuel injection system that dynamically adjusts a ratio between a diesel fuel and a gaseous fuel.

It is an object of the present invention to provide a fuel injection system that dynamically adjusts the ratio between diesel and gaseous fuel based upon an engine's output power and engine speed.

It is an object of the present invention to provide a fuel injection system utilized in a blended fuel controller to adaptively adjust the blending ratio of a diesel fuel with a gaseous fuel to reduce the diesel fuel consumption by introduction and blending of a gaseous fuel of greater or less energy content than diesel fuel to maintain engine performance and fuel economy.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a diagram of fuel injection system, in accordance with one embodiment of the present invention.

FIG. 2 illustrates a diagram of a blended fuel engine block, in accordance with one embodiment of the present invention.

FIG. 3 illustrates a diagram of a blended fuel injector control unit, in accordance with one embodiment of the present invention.

FIG. 4 illustrates a block diagram of a fuel injection system utilized with a diesel engine, in accordance with one embodiment of the present invention.

FIG. 5 illustrates a blended fuel controller for a HPI-TP system based diesel engine, in accordance with one embodiment of the present invention.

FIG. 6 illustrates a block diagram of a metering actuator drive signal modification circuit, in accordance with one embodiment of the present invention.

FIG. 7 illustrates a gas fuel injector driver circuit for one cylinder, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

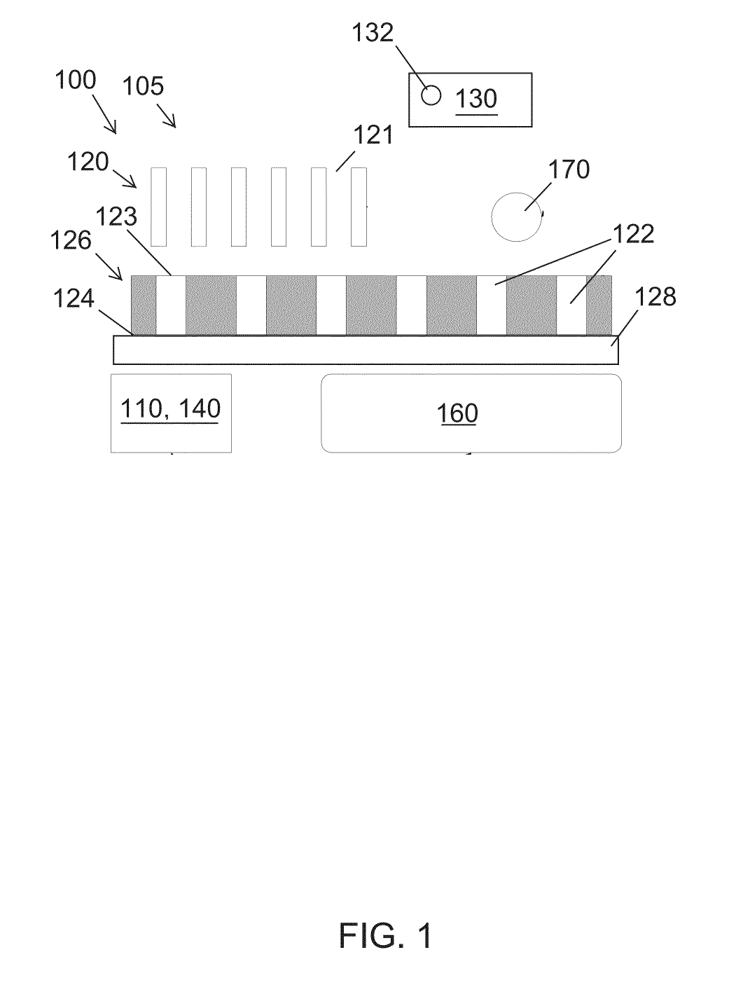

FIG. 1 illustrates a fuel injection system 100, in accordance with one embodiment of the present invention. The fuel injection system 100 can be a heavy duty pressure injection time pressure fuel injection system 105. The fuel injection system 100 can operate on a blended or mixed fuel of gaseous natural gas such as compressed natural gas or CNG or liquefied natural gas or LNG and diesel fuel.

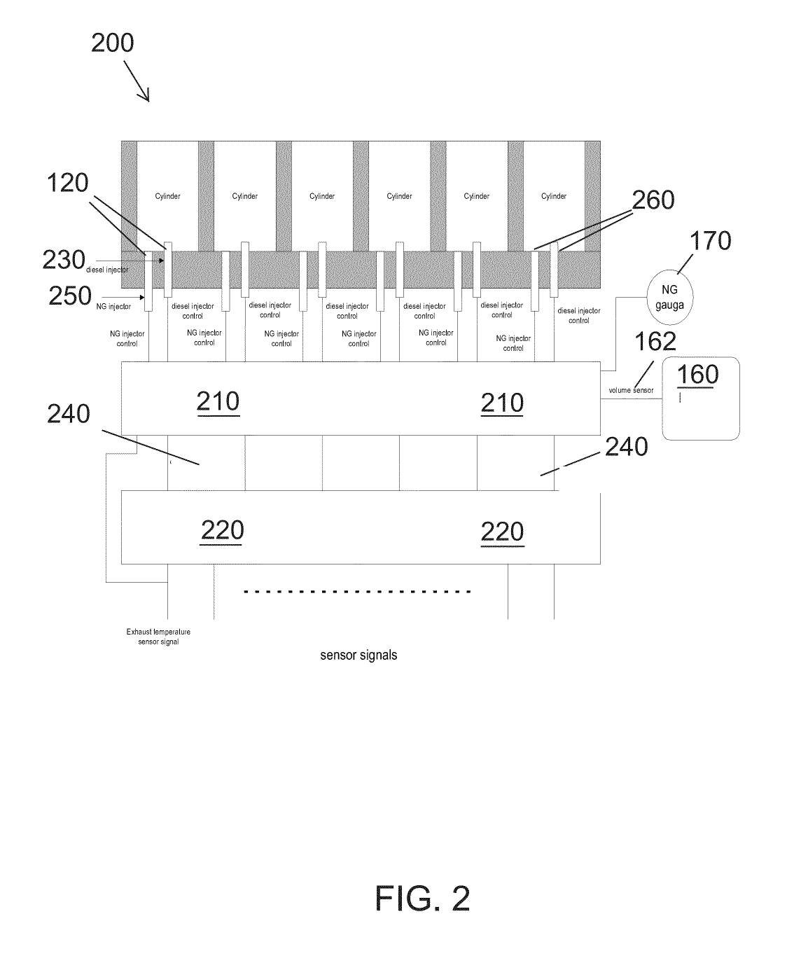

The port injector system 100 may include a blended fuel injector control unit or BFICU (FIG. 2, 210), a plurality of gaseous fuel injectors 120 and an on and off switch assembly 130. The electronic controller 110 may sense engine speed, may calculate energy required by an engine existing control unit or ECM 112 based upon a signal sent to one or more diesel injection pressure and timing actuators 114. The electronic controller 110 reduces a diesel injection volume or energy and replaces it with a like energy level of CNG or LNG by controlling gaseous injector timing and pulse width. The gaseous fuel injectors 120 may respond to commands from the electronic controller 110 and inject gaseous fuel through an injection tube 122 installed in an intake adapter plate 124 fixed between an intake manifold 126 and an engine block 128. The gaseous fuel injectors 120 may deliver sequentially a specified energy quantity through a plurality of gaseous injection tubes 121 to the engine intake valve port 123. The on and off switch assembly 130 may be equipped with a self-diagnostic capability that lights a light emitting diode light or LED light 132 when a fault in the port injector system 100 is sensed. A fault may include improper gaseous injector function, a short or an open circuit or other suitable failure. When the LED light 132 may be lit the port injector system 100 may be automatically turned off. The fuel injection system 100 may also be automatically turned-off when the gaseous fuel pressure is low (i.e., approximately below 65 PSI), in which case, another LED light (not shown) may be lit. The fuel injection system 100 may also be turned off manually as well. The on and off switch assembly 130 may be disposed on a dashboard of a vehicle (not shown) or other location to indicate proper operation of the BFICU (FIG. 2, 210). The fuel injection system 100 may also include a blended fuel injector control unit or BFICU (FIG. 2, 210), a modified engine intake manifold 150, a gaseous fuel storage tank 160 and a gaseous fuel gauge 170. The modified engine intake manifold 150 may accept the gaseous injection tubes 121. The gaseous fuel storage tank 160 also may include a volume sensor 162. The gaseous fuel gauge 170 may also be remotely mounted.

FIG. 2 illustrates a diagram of a blended fuel engine block 200, in accordance with one embodiment of the present invention.

The BFICU 210 may be installed between the ECM 220 and the diesel fuel injectors 230 as shown in FIG. 2Error! Reference source not found. The BFICU 210 has additional injector driver outputs 240 for the add-on gaseous fuel injectors 250. The gaseous fuel injectors 250 may be installed in a common gaseous fuel supply rail and connected individually to the respective gaseous injector tube installed in the modified intake manifold. The gaseous fuel may be injected sequentially into the engine's intake valve ports 260 or SPI while the diesel fuel may be injected directly into the combustion chamber. The blending of the two fuels may take place in each cylinder's combustion chamber.

The BFICU may monitor the injector control signals from the ECM to determine the following parameters: the engine speed (typically in RPMs), the timing of the diesel fuel injection, and the desired energy injection rate. The BFICU may calculate the ratio of the diesel-to-gaseous fuel mix based upon the engine speed and the known OEM designed energy injection rates obtained from OEM data and verified from dynameter tests. The BFICU may then determine the gaseous fuel injection timing and injection duration from the diesel injection timing signal and the calculated engine speed. The BFICU may control the gaseous fuel volume and adjusts the injection signal of the diesel injectors or the diesel volume control actuator to deliver the proper amount of both fuels at the proper time. The BFICU thus proportions the OEM designed energy per injection between the gaseous fuel and the diesel fuel resulting in a seamless transition from diesel to blended gaseous fuel without excessive or reduced energy (over fuel or under fuel) of the diesel engine. Since the total energy in each cylinder may be within the OEM design limits, no sensed engine parameters may be adversely impacted.

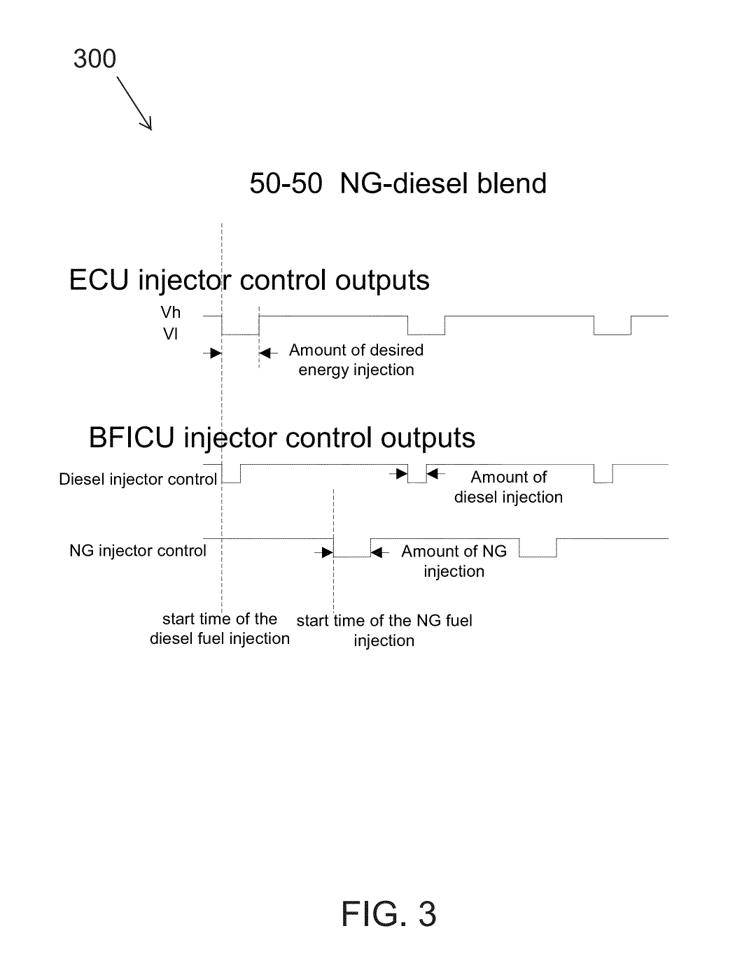

FIG. 3 illustrates a diagram of a blended fuel injector control unit 300, in accordance with one embodiment of the present invention.

The BFICU 300 may set the diesel-to-gaseous fuel ratio high so that the engine runs mostly on diesel when the desired energy injection rate is high and the engine speed is low (high torque) or when the designed energy injection rate is high and the engine speed is high (high horse power). Otherwise, the BFICU 300 progressively increases the proportion of the gaseous fuel in the gaseous fuel injection as the desired energy injection ratio goes lower. FIG. 3 shows the injector control signals for a 50-50 fuel blend. The maximum substitution ratio may be artificially capped at 80% gaseous fuel to 20% diesel fuel.

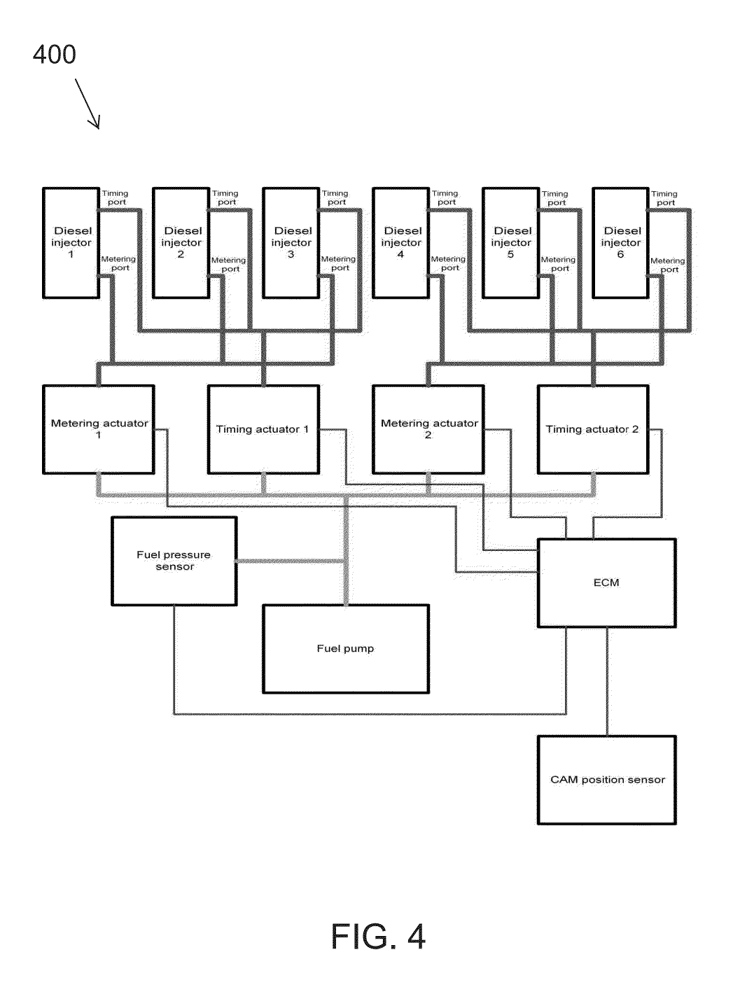

FIG. 4 illustrates a block diagram of a HPI-TP based diesel engine fuel system 400, in accordance with one embodiment of the present invention.

A diesel engine utilizes mechanical fuel injectors with a fuel metering port and a fuel timing port. Diesel fuel may be delivered into the fuel injectors through these ports in bursts before each fuel injection. The fuel delivered through the injector metering port determines the amount of diesel fuel injected per injection event. The fuel delivered through the timing port may be utilized as hydraulic fluid to control the timing of the fuel injection event (i.e., the amount of timing advance or retard of the injection starting point relative to TDC).

The amount of diesel fuel delivered into the metering port of an HPI-TP injector may be electronically controlled through the metering actuator by the engine ECM. To start or stop the fuel delivery, the ECM turns “ON” and off the actuator. The duration of the actuator “ON” pulse may determine the amount of fuel delivered to the injector. The amount of fuel delivered through the timing port of a fuel injector may be similarly controlled by the timing actuator. The HPI-TP based diesel engine fuel system 400 does not interact with the HPI-TP timing actuators. More fuel delivered to the timing port advances the fuel injection. Less fuel delivered to the timing port retards the fuel injection. The diesel fuel injectors may be actuated mechanically. The actual fuel injection may be accomplished by a plunger driven by a rocker arm and camshaft. When the plunger is driven down, the diesel fuel in the metering chamber may be injected into the cylinder.

To substitute the diesel fuel with the gas fuel, the blended fuel controller reduces the amount of diesel fuel delivered to the metering port of the diesel injector. The blended fuel controller also analyses the engine speed and the cycle timing information in order to time the injection of the gaseous fuel. The diesel fuel delivery to the metering port of the diesel injector may be reduced by reducing the “ON” signal pulse duration sent by the ECM to the metering actuator. The engine speed and cycle timing may be derived from the CAM position sensor output. The amount of diesel fuel reduced may be calculated from the duration of the metering actuator “ON” signal and the fuel rail pressure measurement.

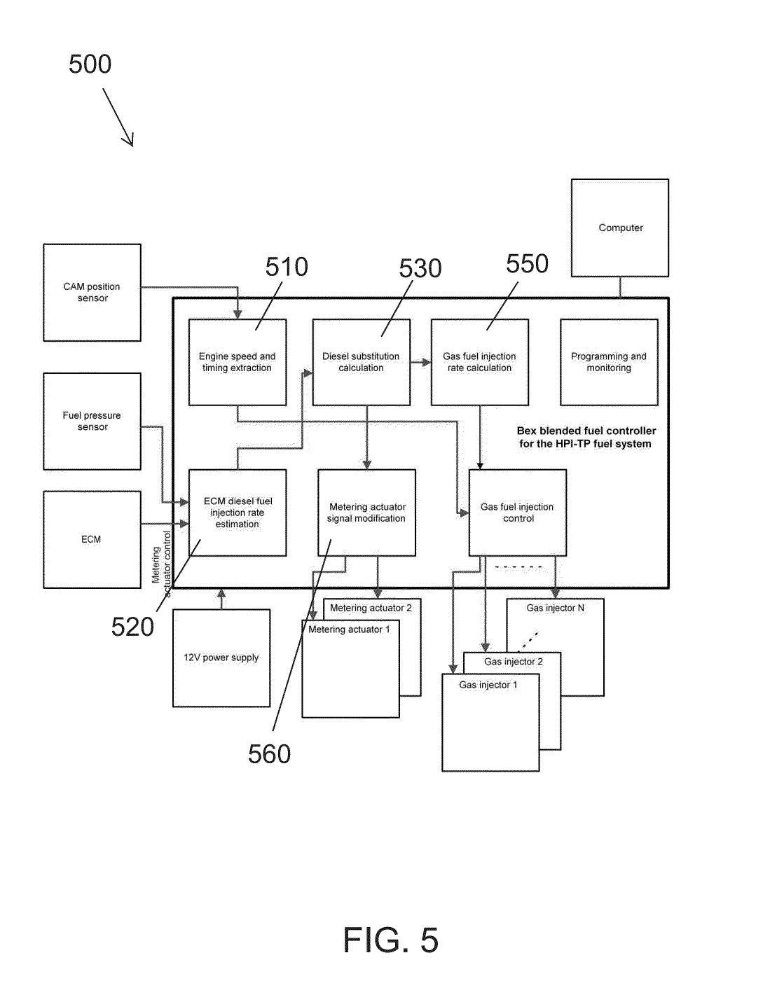

FIG. 5 illustrates a blended fuel controller 500 for a HPI-TP system based diesel engine, in accordance with one embodiment of the present invention.

The blended fuel controller 500 may include an engine speed and timing extraction block 510, an ECM diesel fuel injection rate estimation block 520, a diesel substitution calculation block 530, a gaseous fuel injection rate calculation block 550 and a metering actuator signal modification block 560. The engine speed and timing extraction block 510 may extract engine speed and the cylinder cycle timing information from the output of the CAM position sensor. The engine RPM may be calculated and the piston position for each cylinder may be determine in degrees relative to the TDC at the start of the intake stroke. The ECM diesel fuel injection rate estimation block 520 may measure the amount of diesel fuel delivered to the fuel injectors through the metering port, which may be estimated from the fuel rail pressure and the duration of the metering actuator activation time. A fuel map with columns correspond to the activation duration of the metering actuator and rows correspond to the fuel rail pressure may be constructed and utilized to estimate the fuel delivery rate. The fuel rail pressure may be estimated from the output signal of the fuel rail pressure sensor as well. The diesel substitution calculation block 530 calculates the amount of the diesel fuel to be substituted by the gaseous fuel determined from several factors, the minimum duration of the metering actuator activation, the maximum rate of diesel substitution allowed, the engine RPM, and the fuel rail pressure. The gaseous fuel injection rate calculation block 550 calculates the amount of gaseous fuel for each injection calculated from the amount of diesel fuel to be substituted. In addition the duration of the gaseous fuel injector activation may be calculated based upon the flow rate of the injector, the gaseous fuel pressure, and the number of injectors per cylinder. The metering actuator signal modification block 560 substitutes the diesel fuel with the gaseous fuel, the metering actuator may be turned off earlier.

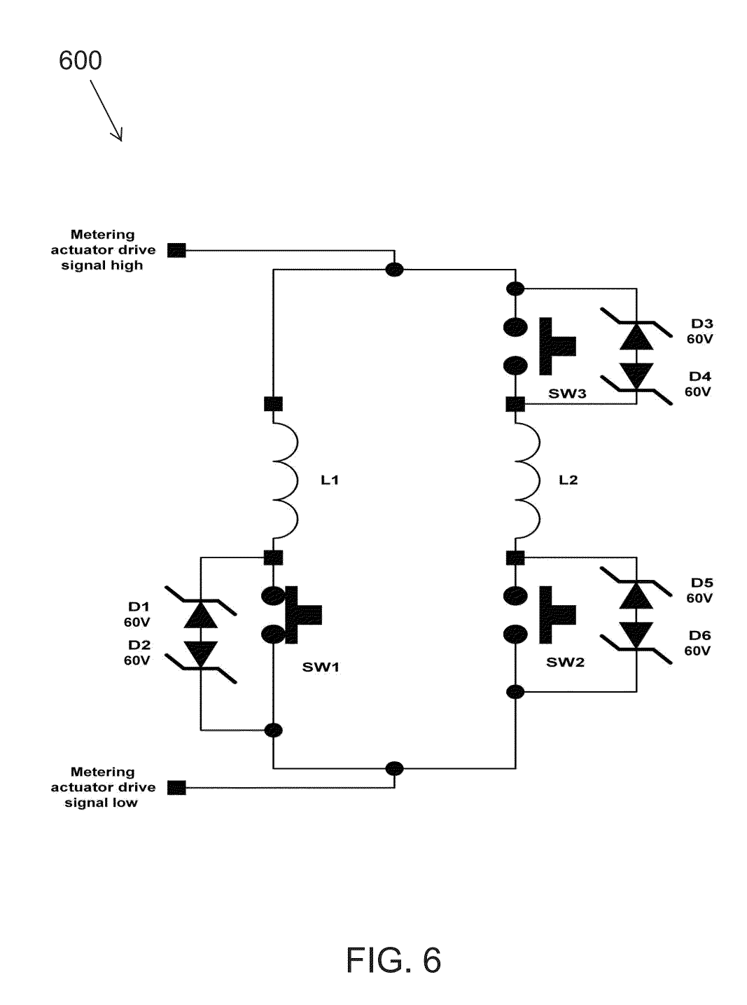

FIG. 6 illustrates a block diagram of a metering actuator drive signal modification circuit 600, in accordance with one embodiment of the present invention.

At the start of the actuator drive signal, switch SW1 may be closed and switch SW2 and switch SW3 may be open. When the duration of the drive signal reaches the value set by the diesel substitution calculation block, SW1 may be opened and SW2 and SW3 may be closed. The current in the actuator coil L1 may continue to flow through the zener diodes D1 and D2. Due to the voltage drop over D1, the current will ramp down rapidly. Meanwhile the current in the coil L2 starts to ramp up. L2 emulates the actuator coil L1 so that the ECM's OBD circuit will not be triggered when the actuator may be turned off by the blended fuel controller. After the end of the actuator drive signal, after the field in L2 has collapsed, SW1 may be turned on again and SW2 and SW3 may be turned off. Since each initial ECM metering actuator signal may be a direct connection between the ECM and the metering actuator, any malfunction of the actuator will immediately be sensed by the engine ECM OBD.

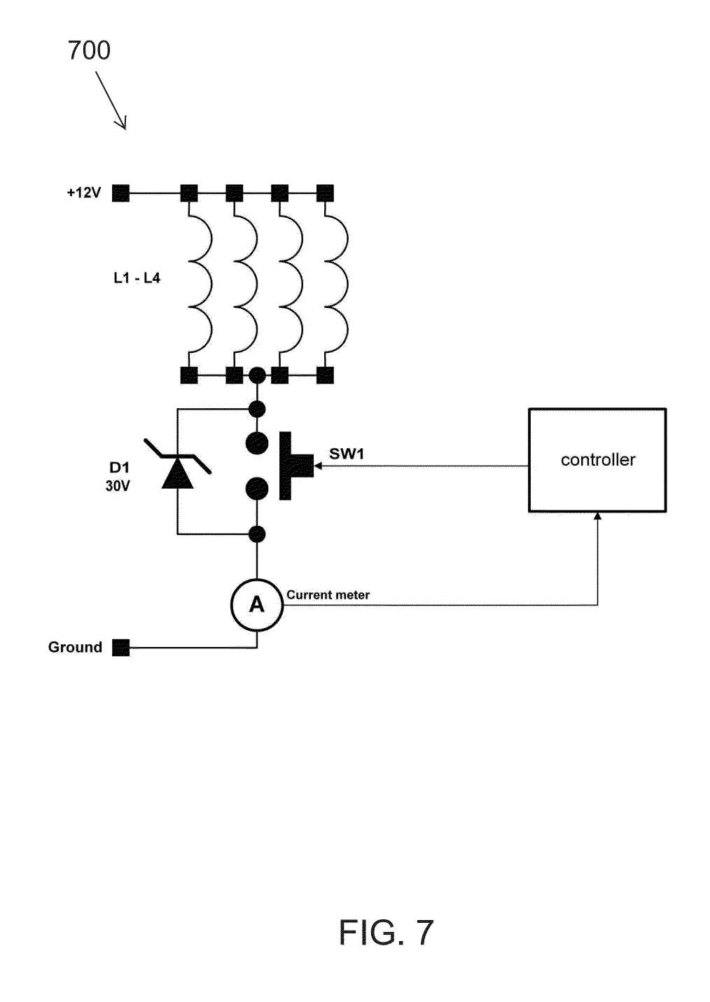

FIG. 7 illustrates a gas fuel injector driver circuit for one cylinder 700, in accordance with one embodiment of the present invention.

The gas fuel injectors may be activated at a specific time and for a specific duration determined from an engine speed and timing estimation and the gas fuel injection rate calculation. The current meter may be utilized to detect the short and the open faults in the injectors. The number of gas injectors (L1-L4) per cylinder may be assumed to be four or any other suitable number.

The port injector system does not sense any engine parameters except engine timing and injector fuel pressure signal pulse. Since the port injector system adjusts the fuel substitution rate entirely from the pulse width of the appropriate signal coming from the engine ECM, all sensed parameters and any adjustments made by the ECM will be included in the ECM signal captured by the BEX controller. All engine ECM OBD circuits remain intact, functioning and uninterrupted by the port injector system. The port injector system does not physically modify any engine emission related components. Modification to the intake manifold to accommodate the installation of the sequential port injection tubes or the addition of an intake system adapter plate to accommodate the installation of the sequential port injection tubes may be the only physical change necessary for system installation and function. The port injector system has no end user adjustable parameters.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A fuel injection system, comprising:
an electronic controller that senses engine speed, calculates energy required by an engine existing control unit based upon a signal sent to one or more diesel injection pressure and timing actuators;
a plurality of gaseous fuel injectors that respond to commands from the electronic controller and inject gaseous fuel through an injection tube installed in an intake adapter plate fixed between an intake manifold and an engine block; and
an on and off switch assembly equipped with a self-diagnostic capability that lights an LED light when a fault in the port injector system is sensed.

2. The fuel injection system according to claim 1, wherein the electronic controller reduces a diesel injection volume or energy and replaces it with a like energy level of CNG or LNG by controlling gaseous injector timing and pulse width.

3. The fuel injection system according to claim 1, wherein the gaseous fuel injectors deliver sequentially a specified energy quantity through a plurality of gaseous injection tubes to an engine intake valve port.

4. The fuel injection system according to claim 1, wherein the fault is an improper gaseous injector function, a short circuit or an open circuit.

5. The fuel injection system according to claim 1, wherein the fuel injection system is a heavy duty pressure injection time pressure fuel injection system.

6. The fuel injection system according to claim 1, wherein the fuel injection system operates on a blended fuel or a mixed fuel of gaseous natural gas and diesel fuel.

7. The fuel injection system according to claim 6, wherein the gaseous natural gas compressed natural gas or liquefied natural gas.

8. The fuel injection system according to claim 1, further comprising a blended fuel injector control unit.

9. The fuel injection system according to claim 1, further comprising a gaseous fuel storage tank.

10. The fuel injection system according to claim 1, further comprising a gaseous fuel gauge.

11. A heavy duty pressure injection time pressure fuel injection system, comprising:
an electronic controller that senses engine speed, calculates energy required by an engine existing control unit based upon a signal sent to one or more diesel injection pressure and timing actuators;
a plurality of gaseous fuel injectors that respond to commands from the electronic controller and inject gaseous fuel through an injection tube installed in an intake adapter plate fixed between an intake manifold and an engine block;
an on and off switch assembly equipped with a self-diagnostic capability that lights an LED light when a fault in the port injector system is sensed; and
a blended fuel injector control unit installed between an ECM and a plurality of diesel fuel injectors.

12. The fuel injection system according to claim 11, wherein the electronic controller reduces a diesel injection volume or energy and replaces it with a like energy level of CNG or LNG by controlling gaseous injector timing and pulse width.

13. The fuel injection system according to claim 11, wherein the gaseous fuel injectors deliver sequentially a specified energy quantity through a plurality of gaseous injection tubes to an engine intake valve port.

14. The fuel injection system according to claim 11, wherein the fault is an improper gaseous injector function, a short circuit or an open circuit.

15. The fuel injection system according to claim 11, wherein the fuel injection system operates on a blended fuel or a mixed fuel of gaseous natural gas and diesel fuel.

16. The fuel injection system according to claim 15, wherein the gaseous natural gas compressed natural gas or liquefied natural gas.

17. The fuel injection system according to claim 11, wherein the blended fuel injector control unit sets a diesel-to-gaseous fuel ratio so that the engine runs mostly on diesel, when the desired energy injection rate is high and the engine speed is low or when the designed energy injection rate is high and the engine speed is high.

18. The fuel injection system according to claim 11, wherein the blended fuel injector control unit progressively increases a proportion of the gaseous fuel in the gaseous fuel injection as a desired energy injection ratio goes lower.

19. The fuel injection system according to claim 11, further comprising a gaseous fuel storage tank.

20. The fuel injection system according to claim 11, further comprising a gaseous fuel gauge.
